(19) United States
(12) Patent Application Publication
(10) Pub. No.: US 2026/0360266 A1
(43) Pub. Date: Nov. 12, 2026

(54) SYSTEM FOR GENERATION OF AUTOMATIC EMAIL FOR REINFORCEMENT LEARNING-BASED TRAINING

(71) Applicant: CheckMAL Inc., Gyeonggi-do (KR)

(72) Inventor: Hwan Gui CHOI, Gyeonggi-do (KR)

(73) Assignee: CheckMAL Inc., Gyeonggi-do (KR)

(21) Appl. No.: 19/670,554

(22) Filed: May 7, 2026

(30) Foreign Application Priority Data
May 12, 2025 (KR) 10 2025 0061332

(51) Int. Cl. G09B 5/02; G06F 40/40; G06N 3/0475; G06N 3/092

(52) U.S. Cl. CPC G09B 5/02; G06F 40/40; G06N 3/0475; G06N 3/092

(57) ABSTRACT

According to this specification, a method for automatically generating a training email based on reinforcement learning by a server may include: receiving a command requesting the generation of the training email from a terminal; selecting a topic for the training email through a topic selection module in response to the command; generating, based on the topic, content for the training email through an LLM agent; and generating, based on the content, the training email through an electronic mail (EML) generator.

### BACKGROUND

This specification relates to the field of artificial intelligence (AI) and security technology, and relates to a system that automatically generates optimal training emails, considering preferences, timeliness, and social interest according to countries and occupations by applying deep reinforcement learning.

Recently, companies are strengthening security training by utilizing training phishing emails to counter the security threats posed by phishing emails. In general, training email systems use predefined scenarios or templates to generate email messages. Such a system requires administrators to manually configure attack types, wording, and attachment presence, and then send emails in batches according to a set schedule. After training, users' responses (e.g., link clicks, attachment openings, etc.) are just analyzed to provide simple statistical data, and this information is not directly reflected in subsequent email generation processes.

However, this existing approach has several limitations. First, despite the goal of analyzing user responses to enhance phishing response capabilities, the collected data is not used to generate subsequent training emails, resulting in insufficient iterative learning. Second, emails generated based on static templates struggle to ensure realism, making it easy for users to identify patterns, reducing the immersion and excitement of the training. Third, even when new phishing techniques or the latest security threats emerge, existing templates fail to reflect them, potentially delaying responses to attackers' latest strategies.

In particular, a structure that cannot learn user responses in real time or automatically optimize email topics significantly limits training effectiveness. User response data collected by companies remains mere statistics and is not reflected in training email generation, hindering active learning by trainees. Furthermore, when new attack types emerge, administrators face the burden of manually analyzing and incorporating them.

Consequently, existing training email systems provide trainees with repetitive and predictable emails, and this reduces training effectiveness. Systems that fail to reflect the latest attacker techniques or learn user responses struggle to strengthen their response to phishing threats.

### SUMMARY

This specification is to provide a reinforcement learning-based automatic training email generation system enabling learning while user responses are reflected in real time.

Furthermore, this specification is to propose a method for implementing a system that enables the generation of customized training emails tailored to user characteristics, enabling rapid response to the latest security threats.

The technical aspects to be achieved by this specification are not limited to the technical aspects mentioned above, and other technical aspects not mentioned will be clearly understood by those skilled in the art to which this specification pertains from the detailed description of the specification below.

As an aspect of this specification, a method for automatically generating a training email based on reinforcement learning by a server may include: receiving a command requesting the generation of the training email from a terminal; selecting a topic for the training email through a topic selection module in response to the command; generating, based on the topic, content for the training email through an LLM agent; and generating, based on the content, the training email through an electronic mail (EML) generator.

In addition, the topic selection module may apply the reinforcement learning to learn user response data from the terminal and prioritize high-performance topics.

In addition, the LLM agent may automatically generate an email subject and body optimized for the training email according to a specified prompt.

In addition, the EML generator may generate an EML file based on the content and provide the EML file in a standard format usable by email clients.

In addition, the method may further include receiving feedback corresponding to the training email from the terminal and performing the reinforcement learning.

In addition, the feedback may include information about the user, data about the user who clicked on the email, and click-through rate.

In addition, the method may further include collecting data from the Internet and storing the data in a database, wherein the selecting of the topic for the training email is based on the data for generating the training email.

As another aspect of this specification, a server that automatically generates a training email based on reinforcement learning may include: a communication module; a memory; and a processor for functionally controlling the communication module and the memory, wherein the processor receives a command requesting the generation of the training email from a terminal, selects, in response to the command, a topic for the training email through a topic selection module, generates, based on the topic, content for the training email through an LLM agent; and generates, based on the content, the training email through an electronic mail (EML) generator.

According to embodiments of this specification, a reinforcement learning-based automatic training email generation system capable of learning by reflecting user responses in real time can be provided.

Furthermore, embodiments of this specification enable the generation of customized training emails tailored to user characteristics, enabling a system capable of quickly responding to the latest security threats.

The effects obtainable from this specification are not limited to the effects mentioned above, and other effects not mentioned will be clearly understood by those skilled in the art to which this specification pertains from the description below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device related to this specification;

FIG. 2 is a block diagram of an AI device according to an embodiment of this specification;

FIG. 3 illustrates an automatic training email generation system to which this specification is applicable;

FIG. 4 illustrates a reinforcement learning method of a topic selection module (320) to which this specification is applicable;

FIG. 5 illustrates a method for automatically generating a training email to which this specification is applicable; and

FIG. 6 illustrates an example of a training email to which this specification is applicable.

### DETAILED DESCRIPTION

Hereinafter, embodiments disclosed in this specification will be described in detail with reference to the accompanying drawings, wherein identical or similar components are assigned the same reference numerals regardless of drawing symbols, and redundant descriptions thereof will be omitted. The suffixes “module” and “unit” for components used in the following description are given or used interchangeably only for ease of specification drafting, and do not have meanings or roles that are distinct from each other per se. In addition, in describing the embodiments disclosed in this specification, when it is determined that a detailed description of related known technology may obscure the gist of the embodiments disclosed in this specification, the detailed description thereof will be omitted. In addition, the accompanying drawings are only for facilitating easy understanding of the embodiments disclosed in this specification, and the technical ideas disclosed in this specification are not limited by the accompanying drawings, and it should be understood to include all changes, equivalents, and substitutes included in the spirit and technical scope of this specification.

Terms including ordinal numbers such as first, second, etc. may be used to describe various components, but the components are not limited by the terms. The terms are used only for distinguishing one component from another component.

When a component is referred to as being “connected” or “coupled” to another component, it should be understood that it may be directly connected or coupled to the other component, while other components may also exist in between. On the other hand, when a component is referred to as being “directly connected” or “directly coupled” to another component, it should be understood that no other components exist in between.

The singular expression includes the plural expression, unless the context clearly indicates otherwise.

In this application, terms such as “include” or “have” are intended to designate that the features, numbers, steps, operations, components, parts, or combinations thereof described in the specification are present, and should be understood as not precluding in advance the presence or possibility of addition of one or more other features, numbers, steps, operations, components, parts, or combinations thereof.

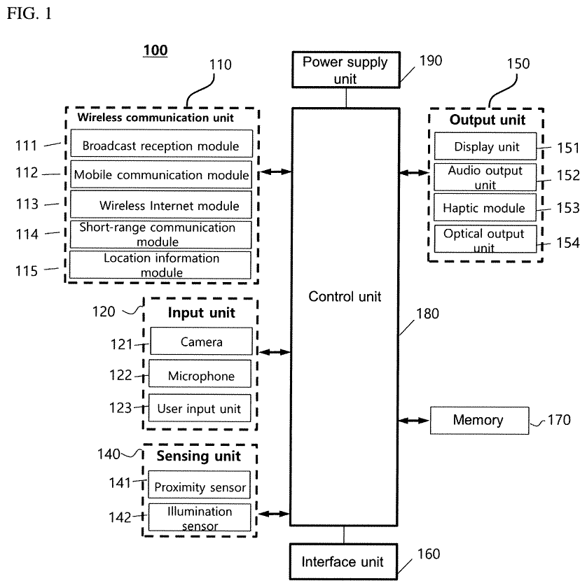

FIG. 1 is a block diagram illustrating an electronic device related to this specification.

The electronic device 100 may include a wireless communication unit 110, an input unit 120, a sensing unit 140, an output unit 150, an interface unit 160, a memory 170, a control unit 180, and a power supply unit 190. The components illustrated in FIG. 1 are not essential for implementing the electronic device, and thus the electronic device described herein may include more or fewer components than those listed above.

More specifically, among the components, the wireless communication unit 110 may include one or more modules that enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short-range communication module 114, and a location information module 115.

The input unit 120 may include a camera 121 or video input unit for video signal input, a microphone 122 or audio input unit for audio signal input, and a user input unit (123, e.g., a touch key, a mechanical key, etc.) for receiving information from the user. Voice data or image data collected by the input unit 120 may be analyzed and processed into user control commands.

The sensing unit 140 may include one or more sensors for sensing at least one of information within the electronic device, information about the surrounding environment surrounding the electronic device, and user information. For example, the sensing unit 140 may include at least one of a proximity sensor 141, an illumination sensor 142, a touch sensor, an acceleration sensor, a magnetic sensor, a gravity sensor (G-sensor), a gyroscope sensor, a motion sensor, an RGB sensor, an infrared sensor (IR sensor), a fingerprint recognition sensor, an ultrasonic sensor, an optical sensor (e.g., a camera (see 121)), a microphone (see 122), a battery gauge, an environmental sensor (e.g., a barometer, a hygrometer, a thermometer, a radiation detection sensor, a heat detection sensor, a gas detection sensor, etc.), or a chemical sensor (e.g., an electronic nose, a healthcare sensor, a biometric sensor, etc.). Meanwhile, the electronic device disclosed herein may utilize information sensed by at least two or more of these sensors in combination.

The output unit 150 is to generate output related to visual, auditory, or tactile sensations and may include at least one of a display unit 151, an audio output unit 152, a haptic module 153, and an optical output unit 154. The display unit 151 may be formed as a touch screen by forming a layered structure with a touch sensor or forming an integrated structure. This touch screen functions as a user input unit 123 that provides an input interface between the electronic device 100 and the user, while also providing an output interface between the electronic device 100 and the user.

The interface unit 160 serves as a path for various types of external devices connected to the electronic device 100. The interface unit 160 may include at least one of a wired/wireless headset port, an external charger port, a wired/wireless data port, a memory card port, a port for connecting a device equipped with an identification module, an audio input/output (I/O) port, a video input/output (I/O) port, and an earphone port. The electronic device 100 may perform appropriate control related to the connected external device in response to the external device being connected to the interface unit 160.

Furthermore, the memory 170 stores data supporting various functions of the electronic device 100. The memory 170 may store data and instructions for the operation of the electronic device 100, and a number of application programs (or applications) running on the electronic device 100. At least some of these application programs may be downloaded from an external server through wireless communication. Additionally, at least some of these applications may be present on the electronic device 100 from the time of shipment for the basic functions of the electronic device 100 (e.g., incoming and outgoing calls, message reception and transmission). Meanwhile, the application programs are stored in the memory 170, installed on the electronic device 100, and driven by the control unit 180 to perform the operations (or functions) of the electronic device.

In addition to the operations related to the application programs, the control unit 180 typically controls the overall operation of the electronic device 100. The control unit 180 processes signals, data, and information input or output through the components described above, or runs application programs stored in the memory 170, thereby providing or processing appropriate information or functions to the user.

Furthermore, the control unit 180 may control at least some of the components described with reference to FIG. 1 to run the application programs stored in the memory 170. Furthermore, the control unit 180 may operate at least two or more of the components included in the electronic device 100 in combination to run the application programs.

The power supply unit 190, under the control of the control unit 180, receives external or internal power and supplies power to each component included in the electronic device 100. The power supply unit 190 includes a battery, and the battery may be an embedded battery or a replaceable battery.

At least some of the components may operate cooperatively to implement the operation, control, or control method of an electronic device according to the various embodiments described below. Furthermore, the operation, control, or control method of the electronic device may be implemented on the electronic device by executing at least one application program stored in the memory 170.

In this specification, the electronic device 100 may be collectively referred to as a server, and the server may include a cloud server. Furthermore, the terminal may include all or part of the electronic device 100 and may include a tablet PC.

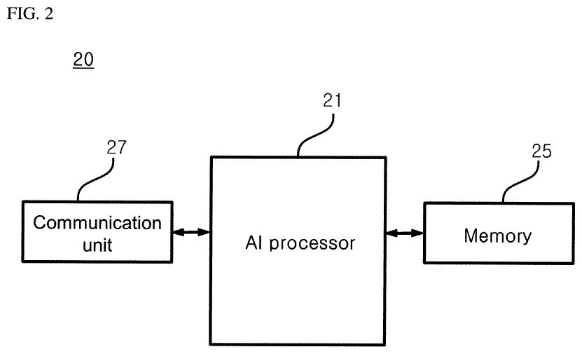

FIG. 2 is a block diagram of an AI device according to an embodiment of this specification.

The AI device 20 may include an electronic device including an AI module capable of performing AI processing, or a terminal including the AI module. Furthermore, the AI device 20 may be included as part of at least a portion of the electronic device 100 illustrated in FIG. 1 and configured to perform at least a portion of the AI processing.

The AI device 20 may include an AI processor 21, memory 25, and/or a communication unit 27.

The AI device 20, which is a computing device capable of learning a neural network, may be implemented in various electronic devices, such as a terminal, desktop PC, laptop PC, or tablet PC.

The AI processor 21 may learn a neural network using a program stored in the memory 25. In particular, the AI processor 21 may automatically select a training email topic based on reinforcement learning and generate an artificial intelligence model that learns user responses to optimize the email content.

For example, the AI processor 21 may analyze user characteristics, national and generational trends, and the latest security threat data to automatically select a training email topic, and may learn user responses (views, clicks, etc.) in real time through a reinforcement learning algorithm to continuously optimize the most effective topic. Furthermore, the AI processor may utilize LLM to automatically generate an email subject and body appropriate to the topic and provide an optimized message to the user using a designated prompt.

User response data (e.g., open rates, click-through rates, response times, etc.) may be collected and analyzed by the AI processor 21, and may be reflected in the reinforcement learning algorithm to improve performance when generating the next training email. In particular, rewards are calculated based on user responses to automatically learn optimal topics and content, and the generated emails are automatically converted into electronic mail (EML) files and provided in a format optimized for email clients (e.g., Outlook, Gmail, etc.).

During this process, the effectiveness of the training emails is maintained by incorporating the security rules of each email client. Through this automated process, the AI processor 21 can increase the efficiency of the training email system and provide an intelligent security training system capable of quickly responding to the latest phishing techniques.

Meanwhile, the AI processor 21, which performs the functions described above, may be a general-purpose processor (e.g., a CPU), but it may also be a dedicated AI processor for AI learning (e.g., a GPU, graphics processing unit).

The memory 25 may store various programs and data required for the operation of the AI device 20. The memory 25 may be implemented as non-volatile memory, volatile memory, flash memory, a hard disk drive (HDD), or a solid-state drive (SDD). The memory 25 is accessed by the AI processor 21, and data may be read/written/modified/deleted/updated by the AI processor 21. Furthermore, the memory 25 may store a neural network model (e.g., a deep learning model) generated through a learning algorithm for data classification/recognition according to one embodiment of the present disclosure.

Meanwhile, the AI processor 21 may include a data learning unit that trains a neural network for data classification/recognition. For example, the data learning unit may acquire learning data to be used for learning and train the deep learning model by applying the acquired learning data to the deep learning model.

The communication unit 27 may transmit the AI processing results generated by the AI processor 21 to an external electronic device.

Here, the external electronic device may include another terminal and/or a server.

Meanwhile, although the AI device 20 illustrated in FIG. 2 is functionally divided into an AI processor 21, memory 25, and communication unit 27, the aforementioned components may be integrated into a single module, referred to as an AI module or artificial intelligence (AI) model.

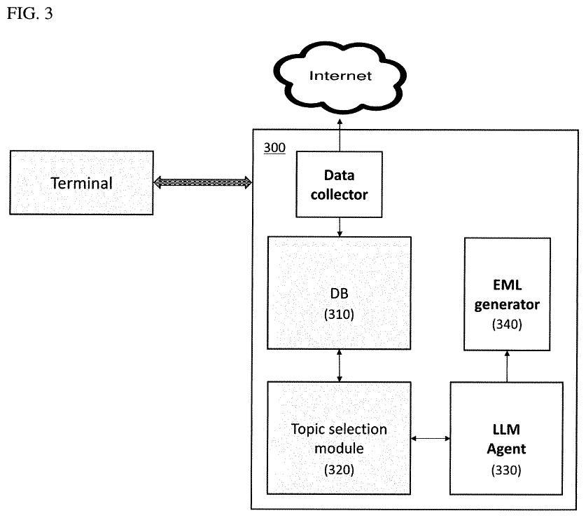

FIG. 3 illustrates an automatic training email generation system to which this specification is applicable.

Referring to FIG. 3, the automatic training email generation system 300 described herein may be implemented as a physical server or cloud server and include a data collector, a database 310, a topic selection module 320, an LLM agent 330, and an Emi generator 340.

The data collector may collect data in real time from various sources (e.g., websites, social media, news, blogs, etc.) on the Internet. For example, this module may automatically collect the latest security issues, phishing techniques, and user interest topics required for training email generation, and continuously update the database 310 with information necessary for topic selection and email generation. The collected data may be refined and stored in the database 310.

Furthermore, the data collector may be configured to collect customized data based on the user's specific interests or the profile of the training subject. For example, for users in the financial sector, information on the latest financial fraud techniques may be collected first, or for users in a specific country, the latest security threats occurring in that country may be prioritized.

The database 310 is a database module that stores and manages data collected by the data collector. This database 310 may store various information for generating training emails in a structured format and categorize and manage the collected data by user characteristics, latest security threats, trends, etc. This data may include phishing-related data, user response data (e.g., open rates, click-through rates), and user feedback data. Furthermore, the database 310 may be linked to the topic selection module 320 to provide data necessary for the reinforcement learning-based topic selection process. For example, email topics with high click-through rates for a specific user group may be used as training data for priority selection in reinforcement learning, contributing to the continuous improvement of the performance of the training system 300.

The topic selection module 320 may automatically select the most effective training email topic for a user based on data provided from the database 310. This module applies a reinforcement learning algorithm to learn user response data in real time and dynamically determines customized topics for each user group. The topic selection module 320 may select the optimal topic by reflecting user characteristics (e.g., country, occupation, age, etc.), recent trends, and security threats. Furthermore, the topic selection module 320 evaluates topic performance based on user response (e.g., open rate, click-through rate, etc.), and topics with high performance may receive higher rewards through reinforcement learning, increasing their likelihood of being selected first. This module also passes the selected topic to the LLM agent 330 to facilitate email generation.

The LLM agent 330 may utilize large-scale language models such as Llama, GPT, and Deep Seek to generate training email content tailored to the topics received from the topic selection module. This module may automatically generate an email subject and body optimized for the user through specified prompts, and provide customized messages that reflect the user's characteristics and current issues. The LLM agent 330 may generate training email text as well as images, links, and interactive elements, and may generate optimized content for seamless use in various email clients (e.g., Outlook, Gmail, etc.). The generated email content is delivered to the EML generator 340.

The EML generator 340 is a module that converts the email content generated by the LLM agent 330 into an EML file format to generate the final training email. The EML file is a standard format usable by email clients and may include the email subject, body, image, link, etc. Furthermore, the EML generator 340 may include links or images to track user responses, enabling training performance measurement. The generated EML file is delivered to the user, and the system 300 performance may be continuously improved based on customer feedback.

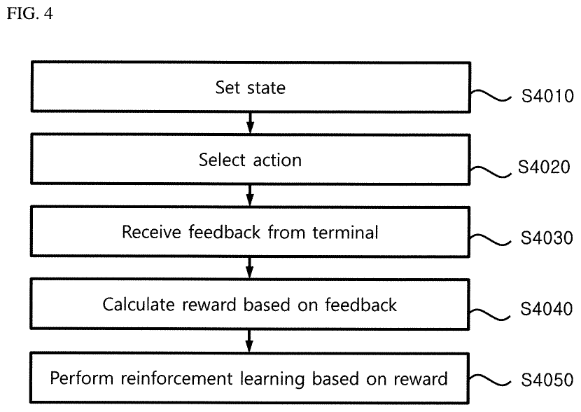

FIG. 4 illustrates a reinforcement learning method of a topic selection module 320 to which this specification is applicable.

Reinforcement learning (RL) is a learning method that allows an agent to learn optimal actions by interacting with its environment. An agent selects an action in a specific situation (state) and receives a reward as a result. To maximize this reward, the agent learns through experience and acquires optimal behavior patterns over time.

Referring to FIG. 4, the topic selection module 320 automatically selects training email topics to provide to users and optimizes performance by learning user response data. For example, the topic selection module 320 may apply a reinforcement learning algorithm to learn user responses (views, clicks) and select increasingly effective topics.

The topic selection module 320 sets a state 54010.

The topic selection module 320 may set a state as an initial condition for selecting training email topics. The state may include any information that affects training, such as user characteristics, current security issues, and past training performance. For example, a user's occupation (finance, IT, medical), age, country, and past training performance (open rate, click-through rate) can be defined as a state. Such a state reflects the characteristics of the user group, enabling customized training.

Such a state may be changed in real time, and the topic selection module 320 may continuously update the states by reflecting user response data. For example, if a user frequently viewed emails related to financial fraud in past training, their state may be set to “Finance User—Interested in Financial Fraud.” This improves the accuracy of topic selection and provides the basis for providing more appropriate training emails to the user.

The topic selection module 320 selects an action S4020.

The topic selection module 320 may select an action based on the configured state. The action refers to the topic selection of training emails, and is the process of determining the topic to which the user will most effectively respond. For example, if the user is in the financial industry and the recent phishing issue is related to financial fraud, the topic selection module may select “Financial Fraud Prevention Training Email” as the topic.

More specifically, action selection may be achieved using an ε-greedy policy in reinforcement learning. The ε-greedy policy may maintain a balance between random exploration (ε probability) and optimal action selection (1−ε probability). Initially, the random selection rate (ε) is high to explore a variety of topics, and the optimal rate increases over time. This scheme allows the topic selection module 320 to learn the user's responses and gradually select the optimal topic.

The topic selection module 320 receives feedback from the terminal S4030.

The topic selection module 320 may receive feedback from the terminal regarding the user's response to opening or clicking on the training email. This feedback serves as an important indicator for quantitatively evaluating user response and may be recorded according to response type, such as opening, clicking, or no response. For example, if the user opened the email, it is recorded as “Open=1,” and if the user clicked, it is recorded as “Click=1.” The topic selection module 320 may use this feedback to determine the effectiveness of each topic. For example, if a specific topic has a high opening rate and click-through rate, it may be assessed as likely to be of interest to the user. This feedback may be collected in real time and utilized in the reinforcement learning process.

The topic selection module 320 calculates a reward based on the feedback 54040.

The topic selection module 320 may calculate a reward based on feedback received from the user. A reward is a value that quantitatively evaluates the positive or negative performance of a user's response. For example, the user may receive a +1 reward for opening a training email, a +2 reward for clicking, and a −1 penalty for not responding. Such a reward value may quantitatively measure the performance of the system 300 and determine the direction of reinforcement learning.

Furthermore, rewards may be set variably depending on user characteristics or training objectives. For example, for financial users, clicks on emails related to financial fraud may be more important, while for general users, the open rate may be a more important indicator. The topic selection module 320 evaluates the performance of each topic and establishes criteria for incorporating them into subsequent learning by using the reward.

The topic selection module 320 performs reinforcement learning based on the reward S4050.

The topic selection module 320 may optimize the topic selection policy by performing reinforcement learning based on the calculated reward value. For example, reinforcement learning may update the Q-value of each topic using the Q-learning algorithm. The Q-value represents the expected performance (cumulative reward) when selecting a specific topic in a specific state, and the system 300 may continuously improve the Q-value by learning user response data.

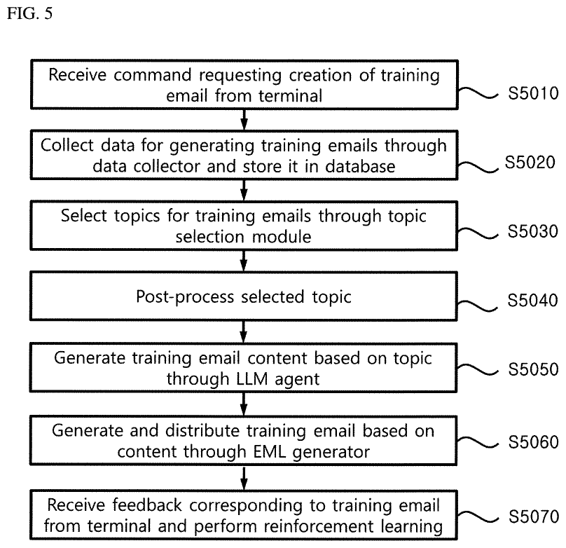

FIG. 5 illustrates a method for automatically generating a training email to which this specification is applicable.

Referring to FIG. 5, the system 300 may automatically generate training emails and deliver them to users through a terminal.

The system receives a command requesting the creation of a training email from the terminal S5010.

The customer transmits a request for training email creation to the system through the terminal, and the system may also receive customer data. For example, customer data may include user characteristics (occupation, age, country) and past training performance (open rate, click-through rate). This data provides basic information for training email generation and may establish a foundation for providing customized training emails to user groups. The more extensive and detailed the customer data, the more accurate the topic selection. For example, the latest financial fraud prevention topics may be selected based on data from a financial industry user group. Conversely, if data is insufficient, general security training topics may be selected. If necessary, the system may acquire additional data through S5020.

The system collects data for generating training emails through a data collector and stores it in a database S5020.

If necessary, the data collector may collect data on the latest security issues, phishing techniques, and user interest topics required for generating training emails from various sources (e.g., websites, social media, news, blogs, etc.) through the Internet. This data may be updated regularly. The collected data may be refined to be utilized for topic selection. The collected data is then stored in a database.

For example, when generating training emails for financial professionals, the data collector may automatically collect recent financial fraud cases, cloud security issues, and phishing email templates. This data provides the basis for effectively selecting topics for training emails to be provided to users.

The system selects the topic for the training email through a topic selection module S5030.

The topic selection module applies a reinforcement learning algorithm based on the collected data to select the optimal training email topic. The reinforcement learning consists of a state, action, and reward structure. By learning user response data, it can be optimized to prioritize high-performing topics. The state may be set based on user characteristics (occupation, age, country) and recent security issues, the action may be determined by topic selection, and reward may be determined by user responses (view rates, click-through rates). For example, in a financial user group, the topic “Preventing the Latest Financial Fraud” may perform well, leading to a higher Q-value.

The system post-processes the selected topic S5040.

The system may further include a topic post-processing module and an image update module. The topic post-processing module may determine whether additional HTML formatting or images are required for the selected topic. Furthermore, if HTML analysis is required, the system may automatically generate HTML structures or modify existing HTML templates in a similar manner to the LLM agent. If images are required, the image update module may create an image appropriate for the topic or retrieve the image from a database.

For example, for a topic on financial fraud prevention, it is possible to include the financial institution's logo in HTML format and add an image depicting a recent financial fraud case. These HTML and image settings are configured to maximize user engagement.

The system generates training email content based on the topic through the LLM agent S5050.

The LLM agent may generate training email content based on the selected topic and HTML and image information transmitted from the topic post-processing module. The LLM agent automatically generates an email subject and body using large-scale language models such as GPT, Llama, and Deep Seek, and may also generate customized content that reflects user characteristics and the latest security threats.

This separation of topic and content generation, where reinforcement learning is applied solely to topic selection, is designed to address the inherent limitations of reinforcement learning. The reinforcement learning is an algorithm that dynamically learns within a state, action, and reward structure, wherein an action selected in a given state is evaluated for performance through a reward, and this evaluation is optimized through learning. However, while content generation relies on the context and grammar of the text, as well as the creativity of the message to be delivered to the user, reinforcement learning struggles to effectively learn this complex language generation process. In particular, text generation allows for an infinite number of expressions, and user responses (views, clicks, etc.) cannot clearly assess sentence-level performance, making it unsuitable for reinforcement learning. On the other hand, topic selection may be directly evaluated through quantitative metrics (click-through rates, view rates), and topic performance can be optimized through reinforcement learning for each user group. Therefore, the present system applies reinforcement learning only to topic selection, while content generation is performed by the LLM agent based on fixed prompts. This maximizes the efficiency of reinforcement learning and maintains the stability of content generation.

Table 1 below provides an example of prompts for the LLM agent to generate training email content.

Referring to Table 1, the prompts may be configured to automatically generate email subject and body (contents) in JSON format.

TABLE 1
Please select an email subject that people related to the following
reference data would click on and an email content corresponding to that
subject. The subject and the email content corresponding to the subject
should be written in Korean, and the data format should be in the
following json format. { “subject” : “”, “contents” : “” } Reference data:

Table 2 below illustrates the data returned when the LLM agent generates training email content.

Referring to Table 2, the returned data includes the email subject and body (contents) in JSON format, and may be dynamically generated based on user characteristics or topics.

TABLE 2
{ “subject”: “Restructuring the workforce and future direction due to AI
adoption”, “contents”: “Hello, our members.\n\nIt is with a heavy heart that we
share with you a significant change in our company. Kakao Corporation recently
implemented an organizational restructuring to enhance AI-based services and
maximize efficiency. As part of this process, new recruitment has been
temporarily suspended, and approximately 10% of our workforce has been
advised to resign.\n\nThis decision was not made lightly and is the result of
intense internal discussion. We ask for your understanding that this is an
inevitable measure to respond to the rapidly changing market and technological
environment and to ensure the company's sustainability and
competitiveness.\n\nDetails and support measures related to this measure will be
announced separately, and all procedures will be conducted as transparently and
fairly as possible. We will also provide practical assistance to those affected by
this change through various solutions, including career transition support,
psychological counseling, and reemployment programs.\n\nThe transition to AI
and efficiency is a new era that we must prepare for together. This makes
cooperation and trust with our remaining members even more important. We
believe this change will enable us to emerge as a stronger and more flexible
organization.\n\nWe understand you may have many concerns and questions.
Please feel free to contact the HR team or reply to this email at any time, and we
will be happy to answer them.\n\nThank you.\n\n- Best regards, Management
Group -” }

The system generates and distributes a training email based on the content through an EML generator S5060.

The content generated by the LLM agent may be converted to EML file format using the EML generator.

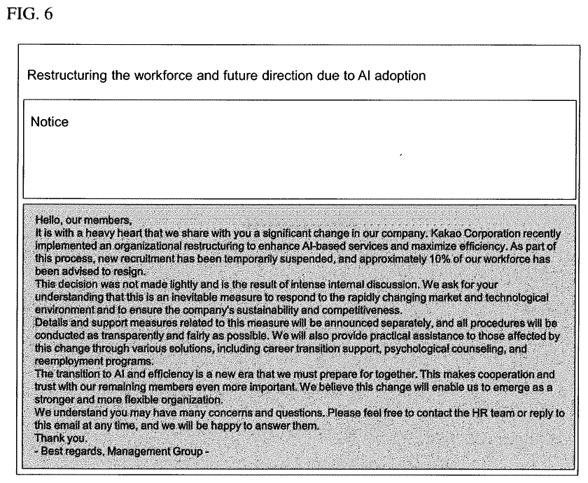

FIG. 6 illustrates an example of a training email to which this specification is applicable.

Referring again to FIG. 5, the EML file is a standard format usable by email clients (e.g., Outlook, Gmail), and may include the email subject, body, image, link, etc. The HTML format is automatically optimized for each client. The generated EML file may then be sent to training target customers through an email distribution service.

The system receives feedback corresponding to the training email from the terminal and performs reinforcement learning S5070.

The system collects user responses to the training email (e.g., views, clicks, etc.) and analyzes the training result data received from the customer.

Here, the collected feedback may include the followings.
1. Customer Information: Company Name, Company Job Title, Average Years of Experience, etc.
2. Clicked Customer Data: Years of Experience [optional], Email Open Time [optional]
3. Click-Through Rate: Click-Through Rate of Training Conducted by the Client [optional], Percentage of Clicked Customers by Year of Experience (n % for 10 years, m % for 5 years, etc.) [optional]

This feedback data may be refined and passed to the topic selection module to be utilized for training.

For example, the topic selection module may evaluate the performance of each topic based on feedback and update the Q-value. Topics with high Q-values are prioritized for subsequent training, while topics with low performance are gradually eliminated.

For example, a financial company, A, recorded a 22% click-through rate for training emails among users with an average of 8 years of experience, and the click-through rate is particularly high among users with 10 years of experience, reaching 25%. In contrast, IT Company B achieved the highest performance with a click-through rate of 35% among users with an average of three and five years of experience. This feedback data may serve as a valuable benchmark for evaluating topic selection performance, reflecting the characteristics of the user group.

This feedback data may be refined and transmitted to a reinforcement learning-based topic selection module. The reinforcement learning algorithm consists of a state, action, and reward structure, and user response data may be used to evaluate the performance of each topic and update the Q-value. For example, at a financial institution, the topic “Preventing Latest Financial Fraud” may have a high click-through rate, increasing its Q-value. Conversely, the Q-value of a low-performing topic may decrease, reducing its likelihood of being selected in the next training session. This Q-value update allows the topic selection module to learn from user responses and provide increasingly effective training emails.

More specifically, Q-value updates may be performed based on the following formula:

$$Q ( s , a ) ← Q ( s , a ) + α [ r + γ max Q ( {s}^{′} , {a}^{′} ) - Q ( s , a ) ]$$

Here, s represents the State, a represents the Action, r represents the Reward, α represents the learning rate, and γ represents the discount rate. This formula quantitatively evaluates the performance of each topic and dynamically adjusts the Q-value by reflecting user response data in real time. For example, if the Q-value of the topic “Preventing Latest Financial Fraud” at financial institution A increases, the likelihood of that topic being selected first in subsequent training sessions increases. As a result, the system can learn user responses and provide increasingly personalized training emails. For example, financial users with a high average years of experience may be provided with the latest financial fraud prevention topics, while IT users may be provided with prioritized cloud security topics. Furthermore, topics with low user response rates are gradually eliminated, retaining only effective training emails. This process is performed in real time, allowing for continuous optimization of training performance based on the characteristics of each user group.

This specification proposes a reinforcement learning-based topic selection system that learns user responses in real time, significantly improving the efficiency of training emails. By collecting user response (views, clicks) data in real time and automatically generating training emails that reflect recent social issues or user interests, the effectiveness and engagement of training can be maximized. This can provide customized training content to each user group, and automatically reflect user response performance to generate increasingly effective training emails.

Furthermore, this specification can significantly reduce training system maintenance costs by minimizing user intervention. Through automated topic selection, email generation, user response analysis, and performance learning, the system can automatically generate and improve optimal training emails without the need for an administrator. This represents a clear structural and functional difference compared to existing manual training systems. In particular, automatically providing user-tailored training through reinforcement learning enables real-time performance, automation, and individual optimization, which were previously unattainable.

The above-described specification may be implemented as a computer-readable code on a program-recorded medium. A computer-readable medium includes any type of recording device that stores data readable by a computer system. Examples of computer-readable media include hard disk drives (HDDs), solid-state disk drives (SSDs), silicon disk drives (SDDs), ROMs, RAMs, CD-ROMs, magnetic tapes, floppy disks, optical data storage devices, and even those implemented in the form of carrier waves (e.g., transmission through the Internet). Therefore, the above detailed description should not be construed as limiting in any respect and should be considered illustrative. The scope of this specification should be determined by a reasonable interpretation of the appended claims, and all modifications within the scope of equivalents of this specification are intended to be included within the scope of this specification.

Furthermore, while the above description focuses on services and embodiments, these are merely examples and are not intended to limit this specification, and those skilled in the art will appreciate that various modifications and applications not illustrated above are possible without departing from the essential features of the services and embodiments. For example, each component specifically described in the embodiments may be modified and implemented. In addition, the differences related to these modifications and applications should be construed as being included within the scope of this specification as defined in the appended claims.

What is claimed is:

1. A method for automatically generating a training email based on reinforcement learning by a server, the method comprising:
receiving a command requesting the generation of the training email from a terminal;
selecting a topic for the training email through a topic selection module in response to the command;
generating, based on the topic, content for the training email through an LLM agent; and
generating, based on the content, the training email through an electronic mail (EML) generator.

2. The method of claim 1, wherein the topic selection module applies the reinforcement learning to learn user response data from the terminal and prioritize high-performance topics.

3. The method of claim 2, wherein the LLM agent automatically generates an email subject and body optimized for the training email according to a specified prompt.

4. The method of claim 3, wherein the EML generator generates an EML file based on the content and provides the EML file in a standard format usable by email clients.

5. The method of claim 4, further comprising receiving feedback corresponding to the training email from the terminal and performing the reinforcement learning.

6. The method of claim 5, wherein the feedback comprises information about the user, data about the user who clicked on the email, and click-through rate.

7. The method of claim 6, further comprising collecting data from the Internet and storing the data in a database, wherein the selecting of the topic for the training email is based on the data for generating the training email.

8. A server that automatically generates a training email based on reinforcement learning, the server comprising:
a communication module;
a memory; and
a processor for functionally controlling the communication module and the memory,
wherein the processor receives a command requesting the generation of the training email from a terminal, selects, in response to the command, a topic for the training email through a topic selection module, generates, based on the topic, content for the training email through an LLM agent; and generates, based on the content, the training email through an electronic mail (EML) generator.
